(19) United States
(12) Patent Application Publication
(10) Pub. No.: US 2016/0126591 A1
(43) Pub. Date: May 5, 2016

(54) GEL ELECTROLYTE FOR AN ELECTROCHEMICAL CELL

(71) Applicant: NAVITAS SYSTEMS, LLC, Woodridge, IL (US)

(72) Inventors: Pu Zhang, Ann Arbor, MI (US); Hongxia Zhou, Ann Arbor, MI (US); Jinjun Shi, San Jose, CA (US)

(21) Appl. No.: 14/897,422

(22) PCT Filed: Jun. 9, 2014
(86) PCT No.: PCT/US2014/041557

§ 371 Date: Dec. 10, 2015

Related U.S. Application Data
(60) Provisional application No. 61/833,117, filed on Jun. 10, 2013.

(51) Int. Cl. H01M 10/0565; H01M 10/42

(52) U.S. Cl. CPC H01M 10/0565; H01M 10/4235; H01M 2300/0085

(57) ABSTRACT

Processes of improving the safety of lithium ion cells are provided without compromising cell performance. Provided are processes of forming a gel electrolyte that for the first time can fully substitute a liquid electrolyte and provide similar performance but also has greatly improved safety. A process includes in situ formation of a gel electrolyte in the presence of a liquid electrolyte material and then subjecting the resulting gel to a wetting step. The resulting gel electrolyte is capable of excellent cycle life and capacity without the presence of remaining liquid electrolyte.

### CROSS REFERENCE TO RELATED APPLICATIONS

This application depends from and claims priority to U.S. Provisional Application No. 61/833,117 filed Jun. 10, 2013, the entire contents of which are incorporated herein by reference.

### FIELD OF THE INVENTION

The invention relates to batteries and method for improving both safety and performance. More specifically, the invention relates to gel electrolytes for use in rechargeable batteries such as lithium ion batteries and methods for improving the performance of the rechargeable batteries.

### BACKGROUND OF THE INVENTION

Lithium ion rechargeable batteries can be grouped according to electrolyte type. This liquid electrolyte is used as a carrier between the positive and negative electrodes in the cell. The materials used in standard liquid electrolytes for lithium ion batteries, however, suffer several complications including a risk of electrolyte leakage and significant flammability of the electrolyte thereby reducing safety of the overall battery system.

Researchers have examined many additives to lithium ion cells to reduce the flammability issue. Previously, materials such as phosphazines have been added directly to the electrolyte to act as a flame retardant. Phosphazines have the benefits of being inherently stable and non-flammable, have very low vapor pressure, and good lithium ion salt dissolution. Viscosity, however, remains an issue with these additives. Also, there remains ample room for improvement of these materials in promoting desirable electrochemical properties to the resulting cells.

In an effort to directly address safety concerns without the need for additives, alternative electrolyte types were sought. Among the most promising are the polymer electrolyte lithium ion batteries. The solid polymeric materials do not suffer a risk of leakage. Another advantage of the solid polymer electrolytes is that they can be manufactured in an ultra-thin battery shape resulting in lighter weight, lower vapor pressures and smaller self-discharge rates as compared to lithium ion batteries that use liquid electrolyte.

The polymer electrolytes historically used are typically either solid polymer materials, polymeric gels, or hybrid materials. The solid electrolytes such as polyether and polysiloxane electrolytes are formed by a solvent evaporation coating process that produces an ultra-thin system. These materials have a lower vapor pressure than the liquid materials. While these materials improve safety relative to the liquid electrolytes, these systems suffer suboptimal performance often owing to separation of the materials from the electrodes thereby reducing battery lifetimes.

The gel-type electrolytes also suffer from poor mechanical properties. To solve this problem, crosslinking agents that are heat or ultraviolet (UV) curable with the gel material are added to the system during electrolyte preparation. Unfortunately, the resulting preformed gel-type electrolyte materials suffer from suboptimal performance due to poor adhesion to the electrode. One way to solve this issue is to polymerize the gel-electrolyte material in situ. The monomer and initiators are dispersed in the liquid electrolyte and cured by thermal or UV methods. One big issue with in situ polymerization, however, is poor wetting of the resulting materials. This results in deterioration of cycle life and power during the battery lifetime.

As such, new methods are needed for producing a safe, high performance rechargeable battery.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The generation of gel electrolytes has historically been performed by either direct deposition onto the electrode by a solvent evaporation process either with or without the addition of a crosslinking agent or by external formation processes. In situ polymerization has been attempted to address the adhesion issues observed with other methods, but wetting issues have plagued these systems resulting in poor electrochemical properties of the resulting cell. The processes provided herein solve these problems by producing a gel electrolyte in situ that has excellent adhesion to the substrate and wetting thereby promoting improved capacity relative to prior gel electrolyte systems.

Accordingly, it is an object of the invention to provide a process of forming a lithium ion cell with improved safety relative to cells incorporating a liquid electrolyte and without the electrochemical costs observed with prior gel electrolyte systems. The present invention provides formation processes for an electrochemical cell to improve both performance and safety. A for formation of an electrochemical cell is provided including: providing a substrate; contacting the substrate with a precursor material, the precursor material including a monomer, oligomer, initiator, or combinations thereof, and a first electrolyte material including one or more lithium salts; polymerizing the precursor material while in contact with the substrate for a polymerization time to form a gel electrolyte; and subsequently wetting the gel electrolyte and substrate with a liquid electrolyte material for a wetting time, optionally 1 to 72 hours. The resulting electrochemical cells demonstrate improved electrochemical performance characteristics as compared to a cell employing a gel electrolyte formed by traditional methods.

In various embodiments, a formation process optionally further includes removal of excess liquid electrolyte material after the step of contacting, where the volume of excess is optionally determined by the volume of the gel, size of the substrate, type of gel electrolyte, or other factors, individually or in combination thereof such that all remaining liquid is trapped within the gel electrolyte and is optionally unable to leak to the environment in the event of a breach. Some embodiments of a formation process include polymerizing through the use of thermal curing or ultraviolet curing. The substrate is optionally an electrode, a separator, or a combination of an electrode or electrodes and separator material(s). The separator is optionally included before the polymerization process with the precursor material or after the polymerization process. Optionally, an electrode includes a cathode material including a lithium metal oxide, or a lithium metal phosphate. Optionally, an electrode includes an anode material of or including: graphite; silicon; a transition metal oxide; or combination thereof. The precursor material optionally includes a flame retardant additive, a current collector protection agent, a protection agent, or any combination thereof. An initiator is optionally included in the precursor and formation process. An initiator is optionally an azo-compound, or a peroxide. Further embodiments exclude the addition of supplemental electrolyte material following polymerization.

### BRIEF DESCRIPTION OF THE DRAWINGS

FIG. 1 illustrates capacity loss over 60 or more cycles of cells with either a traditional liquid electrolyte, a traditionally formed gel electrolyte, or a gel electrolyte formed as described herein;

FIG. 2 illustrates the rate performance of lithium-ion cells with various electrolytes demonstrating performance of a gel electrolyte as formed according to the processes described herein as equivalent to a liquid electrolyte and far superior to a traditionally formed gel electrolyte.

### DETAILED DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a “first” element, component, region, layer, or section discussed below could be termed a “second” (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Methods of forming a gel electrolyte for an electrochemical cell are provided. The invention has utility for improving the performance and safety of secondary batteries such as lithium ion batteries. Methods provided include in situ formation of a gel electrolyte material that may include one or more additives to improve flame resistance and other needed parameters.

A process includes providing a substrate such as electrode, a separator, or both and contacting the substrate with a precursor material and a first electrolyte material including one or more lithium salts. The precursor material is subject to polymerizing for a polymerization time to form a gel in contact with the substrate. A precursor material includes one or more components that are incorporated into or form a gel electrolyte material. Illustrative components of a precursor material include a monomer or oligomer and an initiator, and optionally a crosslinking agent. A process includes polymerizing the precursor material in contact with a substrate in an in situ polymerization process to form a gel electrolyte in contact with the substrate. After a polymerization time, a liquid electrolyte material is added to the gel in a sufficient quantity to soak the gel. The liquid electrolyte is maintained in contact with the substrate and the gel electrolyte for a wetting time. The resulting wetted gel electrolyte shows improved contact with the substrate thereby improving capacity and cycle life of the resulting electrochemical cell.

A substrate is optionally an electrode, a separator, or both. Any electrode or separator material known for use in batteries, optionally lithium ion secondary batteries, may be used. Illustrative examples include LiCoO₂, LiNi_{0.8}Co_{0.15}Al_{0.05}O₂, LiNiₓMn_{y}Co_{z}O₂, LiMn₂O₄ variants, other lithium metal oxides, LiFePO₄, high voltage lithium metal phosphates, graphite and graphite containing materials, transition metal oxides, silicon and silicon containing materials, Li₄Ti₅O₁₂, a polyolefin material (e.g. polyethylene (PE) and polypropylene (PP)), polyethylene terephthalate (PET), poly vinylidene fluoride (PVdF) and composite materials such as γ-LiAlO₂, Al₂O₃, MgO and TiO₂ ceramics with PVdF and CaCO₃-polytetrafluoroethylene (PTFE). Additional optional materials include nickel oxyhydroxide, intermetallic compounds (alloys) comprising of a rare earth metal including neodymium, lanthanum, cerium, or combinations thereof and aluminum, cobalt, manganese, magnesium, nickel, or combinations thereof to form AB₅ compounds; or intermetallic compounds of AB₂ type including titanium, vanadium or combinations thereof and zirconium, nickel, chromium, cobalt, iron, manganese or combinations thereof, or other variants of intermetallic compounds. These materials are presented for exemplary purposes. Other materials useful as an electrode or separator are similarly operable.

A precursor material is formed from at least one lower molecular weight material that is polymerized to form a gel. By lower molecular weight material it is meant that the molecular weight of the precursor material is lower than the polymerized material. Illustratively, a precursor material includes a polymer, copolymer, monomer or an oligomer of either linear or branched configuration. Non-limiting examples of a precursor material include a monomer of polyethylene glycol such as a diacrylate polyethylene glycol, (PEGDA), poly(ethylene glycol)methacrylate, poly(ethylene glycol)dimethacrylate, triethylene glycol diacrylate, triethylene glycol dimethacrylate, or combinations thereof. A precursor material is optionally a reactive nitrogen containing precursor material that is capable of reacting with a halogen or an epoxy containing precursor to form a cross linked gel configuration. Illustrative examples of reactive nitrogen containing compounds are those that have one or more terminal or branch terminal primary, secondary or tertiary amines. Exemplary halide or epoxy-group containing precursor materials include compounds with alkylene halides or halomethyl group substituted aromatic units or at least one epoxy unit. A precursor material is optionally not a reactive amine containing material, a halide material, or an epoxy material as precursor materials that are derivatives of methacrylic acid are believed to demonstrate superior results in the inventive processes. Many precursor materials are commercially available from Sigma-Aldrich, St. Louis, Mo.

A precursor material optionally includes a polymerization initiator. A polymerization initiator is optionally an azo-compound, an inorganic peroxide, or an organic peroxide. Non-limiting examples of a polymerization initiator include 2,2′-azobis(2-methylpropionitrile) and benzyol peroxide.

A precursor material is polymerized (gelled) in the presence of an electrolyte material. A liquid electrolyte material is illustratively a carbonate based electrolyte. Illustratively, the liquid electrolyte material optionally includes a lithium salt and a non-aqueous organic solvent. A lithium salt is optionally LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiCl, LiI, or LiB(C₂O₄)₂ (lithium bis(oxalato)borate; LiBOB). The lithium salt is optionally present in a concentration of 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0 M. Optionally, a lithium salt concentration ranges from about 0.1 M to about 2.0 M or any value or range therebetween. When the lithium salt is included at the above concentration range, an electrolyte may have excellent performance and lithium ion mobility due to optimal electrolyte conductivity and viscosity.

The non-aqueous organic solvent optionally includes a carbonate-based, ester-based, ether-based, ketone-based, alcohol-based, or aprotic solvent. Such solvents are known in the art.

A gel electrolyte is optionally formed by polymerization of the precursor materials in the liquid electrolyte material. The precursor materials are optionally dissolved or suspended into organic liquid electrolytes containing 0.5, 0.6, 0.7, 0.8, 0.9, 1.0, 1.1, 1.2, 1.3, 1.4, 1.5, 1.6, 1.7, 1.8, 1.9, or 2.0 M of ionic salts. Optionally, precursor materials are dissolved or suspended into organic liquid electrolytes containing between about 0.5M to about 2.0M ionic salts forming a solution. The solution is then optionally heated at an elevated temperature (approximately 30-130° C.) for a polymerization time to create a cross-linked reaction product of one or more of the precursor materials to form a high molecular weight ion conductive gel.

The precursor materials are added to an electrolyte material at a concentration of between 1 wt % to 20 wt %, optionally 1 wt % to 15 wt %, optionally 1 wt % to 10 wt %, optionally 1 wt % to 9 wt %, optionally 1 wt % to 8 wt %, optionally 2 wt % to 10 wt %, optionally 3 wt % to 10 wt %, optionally 4 wt % to 10 wt %, optionally 5 wt % to 10 wt %, optionally 5 wt % to 10 wt %, optionally 2 wt % to 5 wt %, optionally 2 wt % to 4 wt %. It has been found that electrochemical properties diminish when the amount of precursor material exceeds 10%. Without being limited to one particular theory, when greater than 10% monomer is present, it becomes difficult to obtain full polymerization leaving excess monomer in the gel. The presence of this excess monomer will lower the conductivity of the resulting gel electrolyte and reduce cycle life due to side reactions occurring during cycling due to the presence of excess monomer. In addition, excess monomer is believed to lead to an excess coating of polymer forming on the electrode active material that may act as an insulator reducing the ability of ions to reach the electrode material. Exceeding 10% also generates an excess density of the polymer material that is believed to lower conductivity in the electrolyte impairing cell performance. The electrolyte material is optionally present to an amount of up to 99 wt % prior to polymerization.

Following polymerization, a wetting volume of a second liquid electrolyte material is then added to the gel and incubated for a wetting time. The second liquid electrolyte material may be the same electrolyte material as used in the polymerization reaction, or may be a different liquid electrolyte material. In a non-limiting example, a second volume of electrolyte material is sufficient to produce a volume of liquid electrolyte and gel as was the volume of the original precursor material prior to the polymerization step of gel formation.

A wetting time may be dependent on the volume of gel and size of the substrate. A typical wetting time is from 1 hour to 72 hours, optionally from 1 hour to 18 hours, optionally from 6 hours to 12 hours. A wetting time is optionally 1, 2, 3, 4, 5, 6, 7, 8, 9, 10, 11, 12, 13, 14, 15, 16, 17, 18, 19, 20, 21, 22, 23, 24, 36, 48, 60, or 72 hours, or any value or range from 1 hour to 72 hours. Depending on the gel electrolyte type, wetting time may be longer or shorter. Illustratively, for an electrochemical cell of single layer stacks 32 mm×46 mm×0.2 mm a soaking time of 12-18 hours is sufficient.

Any excess electrolyte material is optionally removed from the gel following the wetting time. Excess is defined as any volume of liquid that is freely removable from the gel by gravitational forces. The removal of excess liquid electrolyte material improves safety by eliminating the possibility of electrolyte leakage following cell breach. Surprisingly, the removal of additional electrolyte, however, does not adversely affect cell electrochemical performance as the gel electrolyte cells formed as described herein are capable of electrochemical function similar to traditional liquid electrolyte cells, but in the absence of free liquid electrolyte.

A precursor material optionally includes one or more additives. An additive optionally provides additional stability, flame retardation, or other desirable attribute. Some embodiments include a flame retardant additive. A flame retardant additive is illustratively one or more: alkyl phosphates such as trimethyl phosphate (TMP) and triethyl phosphate (TEP); phosphazenes such as hexamethyl phosphazene; compounds with phosphorus substituents; compounds with phosphorus-nitrogen; hydrofluoroethers such as 2-trifluoromethyl-3-methoxyperfluoropentane (TMMP) and 2-trifluoro-2-fluoro-3-difluoropropoxy-3-difluoro-4-fluoro-5-trifluoropentane (TPTP); and combinations thereof. The amount of flame retardant will depend on the identity of the retardant and the desired outcome. Illustratively, a flame retardant is provided at a concentration of 5% to 50%, or any value or range therebetween relative to the precursor materials. Optionally a flame retardant is provided at a concentration of 5% to 25%, optionally 5% to 15%, optionally 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight.

An additive is optionally a current collector protection agent. Illustrative examples of current collection protection agents include succinonitrile. A current collection protection agent is optionally provided at 0.1% to 3% by weight or any value or range therebetween, optionally 0.1% to 1% percent by weight, optionally 0.1, 0.2, 0.3, 0.4, 0.5, 0.6, 0.7, 0.8, 0.9, or 1% by weight.

An additive is optionally a protection agent. A protection agent is any molecular agent that when added to the electrolyte, electrode, separator, casing, or any other portion of an electrochemical cell will improve the safety of the device. Illustrative activities of a protection agent include materials that will improve the physical stability of the gel electrolyte, hygroscopic material that is capable of sequestering water thereby reducing side reactions due to moisture within a cell, a molecular scavenger that is capable of sequestering or absorbing gas or organic molecules thereby reducing flammability, or reduces the vapor pressure of the electrolyte. Some flame retardants may have multiple functionalities or function to reduce flammability via one of the above mechanisms and can therefore also be considered a protection agent. Illustrative examples of protection agents include oxides of Al, Si, or other elements. Specific examples include SiO₂ and Al₂O₃.

The gel electrolytes according to the present invention illustrate 80% capacity retention for 80 or more cycles whereas traditional electrolytes lose capacity down to 80% by 12-18 cycles. As such, a gel electrolyte according to the invention provides 80% or greater capacity for 20 or more cycles, optionally 25 or more cycles, optionally 30 or more cycles, optionally 35 or more cycles, optionally 40 or more cycles, optionally 45 or more cycles, optionally 50 or more cycles, optionally 55 or more cycles, optionally 60 or more cycles, optionally 65 or more cycles, optionally 70 or more cycles, optionally 75 or more cycles, optionally 80 or more cycles, optionally 85 or more cycles, optionally 90 or more cycles.

Electrochemical cells formed by the above processes including a rewetted gel electrolyte material produced as per the invention has indistinguishable or improved electrochemical performance characteristics relative to the liquid electrolyte materials alone, yet offer improved safety, ability to be used in small or shaped cell structures, and other benefits relative to liquid electrolyte cells.

Various aspects of the present invention are illustrated by the following non-limiting examples. The examples are for illustrative purposes and are not a limitation on any practice of the present invention. It will be understood that variations and modifications can be made without departing from the spirit and scope of the invention. Reagents and materials illustrated herein are commonly cross reactive between mammalian species or alternative reagents with similar properties are commercially available, and a person of ordinary skill in the art readily understands where such reagents may be obtained.

### EXPERIMENTAL

An electrochemical cell is assembled using an in situ formed gel electrolyte. The cell cathode was formed from 93 wt % lithium nickel cobalt manganese (NCM), 3 wt % conductive carbon, and 4 wt % polyvinylidene fluoride (PVDF) dispersed in N-methyl oyrrolidone (NMP) and mixed. The slurry was casted on aluminum foil. The cathode material was dried at 120° C., compressed then pouched with matched-metal die to form the positive electrode. An aluminum strip was welded to the foil to serve as positive terminal.

The anode was constructed of 90 wt % graphite-Si composite, 10 wt % polyvinylidene fluoride (PVDF) dispersed in N-methyl oyrrolidone (NMP) that was mixed and the resulting slurry casted on copper foil. The anode material was dried, calendared, and then pouched with matched-metal die to form the negative electrode. Nickel strip was welded to the copper foil to serve as the negative terminal.

The cathode and anode were stacked with a separator of porous polyethylene (20 μm thick) and vacuum dried at 70° C. for 2 days before transferring to a glove box. A gel electrolyte precursor material is formed by adding 2.5 wt % poly(ethylene glycol)diacrylate (PEGDA, average molecular weight 250 Da) to a carbonate based liquid electrolyte including 1.15M LiPF₆ and benzoyl peroxide (BPO) (LUPEROX A98) added as and initiator in an amount of 5% by weight based on the monomer PEGDA. The precursor material was used to fill the cells followed by pre-soaking for several hours. Excess liquid electrolyte was drained. The cells were sealed and heated at 60° C. for 3 hrs to polymerize the monomers. Following polymerization, excess liquid electrolyte was added to the cells and soaked for a wetting time of 24 hrs before draining. The resulting cells were resealed for testing.

As a control a second cell (gel cell) is formed using the same materials and parameters as above with the exception that no additional liquid electrolyte is soaked in with the polymerized gel electrolyte following gel formation.

A liquid electrolyte only cell is formed as above without the gel precursor material added and used as a liquid electrolyte baseline control cell.

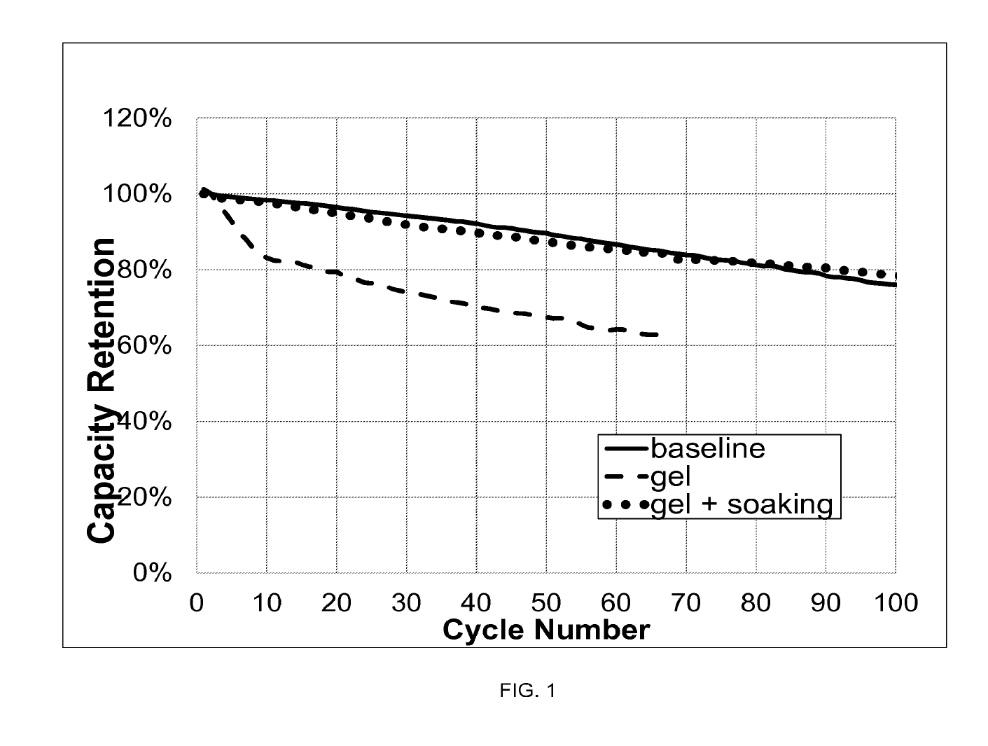

The three cells (liquid electrolyte baseline; gel electrolyte; and gel electrolyte subjected to additional wetting step) are tested for capacity and cycle life. Li-ion cell voltage is cycled 3.0-4.2V and the reversible storage capacity in terms of product of baseline is plotted against cycle number. Cell cycle life is evaluated at room temperature at a +0.5C/−0.5C rate. The cells with a gel electrolyte formed with the additional wetting step do not suffer the irreversible capacity loss (ICL) of the same material formed absent the wetting step (FIG. 1). Also, the wetted gel electrolyte cell performed substantially identical to cells formed with the liquid electrolyte material alone (FIG. 1).

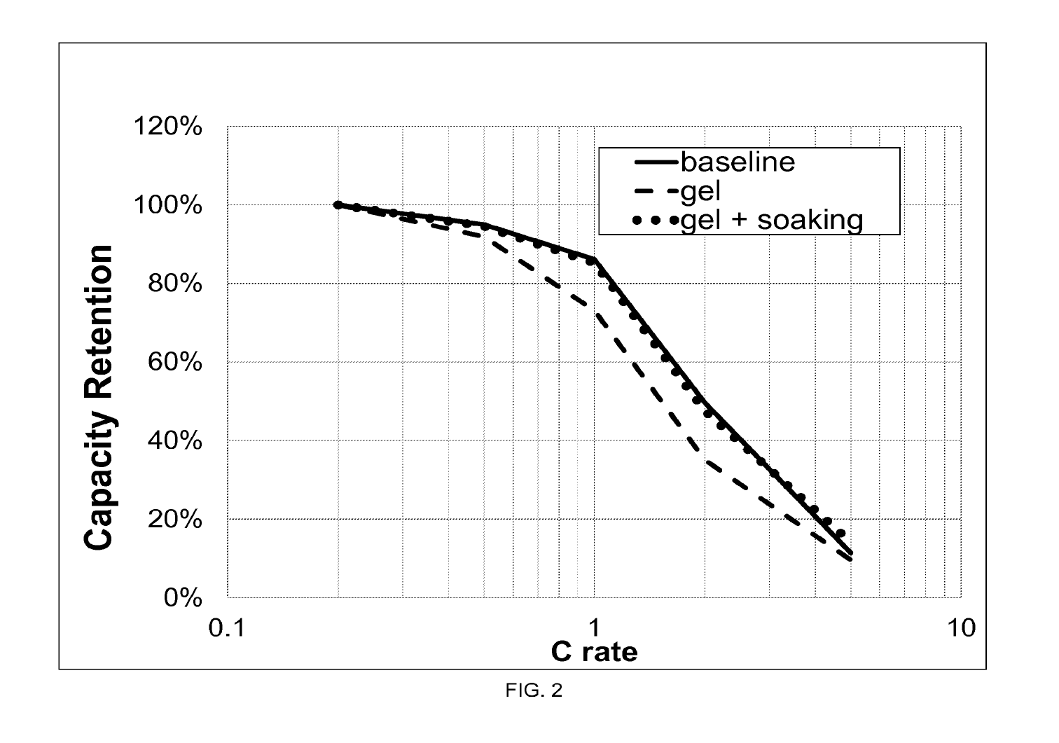

The three cells are also tested for rate capabilities. Li-ion cell voltage is cycled 3.0-4.2V with a C/5 charge rate and discharge rates of 0.2C, 0.5C, 1C, 2C and 5C with the resulting capacity retention plotted against rate. Cells with the rewetted gel electrolyte perform indistinguishably from cells with liquid electrolyte alone and much better than cells with a gel electrolyte formed as per traditional methods (FIG. 2).

A fourth cell is formed with a gel electrolyte as per the above procedure with the addition of 10% by weight of the flame retardant HISHICOLIN E (NIPPON CHEMICAL INDUSTRIAL CO., LTD) present in the initial liquid electrolyte material. Following polymerization of the gel electrolyte, the wetting step is performed in liquid electrolyte including both 10% HISHICOLIN E (2-Ethoxy-2,4,4,6,6-pentafluoro-2λ⁵,4λ⁵,6λ⁵-[1,3,5,2,4,6]triazatriphosphinine, Ethoxypentafluorocycrotriphosphazene/Cyclotriphosphazene EO/F(1/5)), and 0.3 wt % succinonitrile as a collector protection agent. The fourth cell is tested as above and demonstrates similar electrochemical properties as the gel+soaking cell.

The various cells with differing electrolytes (liquid, gel+soaking, flame retardant gel+soaking) are then subjected to an open cup method to determine safety profiles. For the open cup test, ˜1 gram of electrolyte (liquid or gel) was added to an aluminum disk, which was placed on a 60° C. hot plate. After 60 sec, the electrolyte was exposed to a flame for 3 sec. The flame was removed and the time the electrolyte continues to burn was measured and recorded as flame last.

The results are presented in Table 1.

TABLE 1

| Electrolyte | Flame last (second) |
|---|---|
| liquid electrolyte | 40 |
| gel electrolyte | 15 |
| gel + 10% flame- | 5 |
| retardant | |

As is seen in Table 1, the liquid electrolyte material suffers significant flame last. The wetted gel electrolyte alone displays significant safety improvement as demonstrated by reduced flame last by greater than 60%. The addition of a flame retardant to a wetted gel electrolyte at 10% reduces the flame last by nearly 90%.

Overall, these results demonstrate that forming a gel electrolyte according to the invention produces a cell with similar capacity and power to cells with standard liquid electrolyte and far superior to cells with gel electrolyte as traditionally formed. Importantly, the cells with the gel electrolyte formed as per the invention are far superior in safety relative to liquid electrolytes. Thus, the gel electrolyte formed as per the invention demonstrates the safety advantages of gel electrolytes with the performance of liquid electrolytes, thereby addressing the long felt need for simultaneous improvements in both safety and performance of lithium-ion batteries.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A process for formation of an electrochemical cell comprising:
providing a substrate;
contacting said substrate with a precursor material, said precursor material comprising a monomer, oligomer, initiator, or combinations thereof, and a first electrolyte material comprising one or more lithium salts;
polymerizing for a polymerization time said precursor material to form a gel in contact with said substrate; and
contacting a second liquid electrolyte material with said gel and said substrate for a wetting time.

2. The process of claim 1 further comprising removing excess liquid electrolyte material from said gel following said contacting step.

3. The process of claim 1 or 2 wherein said step of polymerizing comprises thermal curing or ultraviolet curing.

4. The process of claim 1 or 2 where said wetting time is from one to seventy-two hours.

5. The process of claim 1 or 2 wherein said substrate is an electrode; said electrode is a cathode comprising a lithium metal oxide, a lithium metal phosphate, or combinations thereof; or said electrode is an anode comprising a graphite or graphite containing material, a silicon or silicon containing material, a transition metal oxide, or combinations thereof.

6. The process of claim 1 or 2 wherein said precursor material further comprises a flame retardant additive.

7. The process of claim 1 or 2 wherein said precursor material further comprises a current collector protection agent, a protection agent, or combinations thereof.

8. The process of claim 1 or 2 wherein said initiator is an azo-compound, or a peroxide.

9. The process of claim 1 or 2 wherein said substrate is an electrode, a separator, or more than one substrate is present where a first substrate is an electrode and where a second substrate is a separator.

10. The process of claim 1 or 2 further comprising contacting said precursor material with a separator prior to said step of polymerizing.

11. The process of claim 1 or 2 further comprising incorporating said substrate and said gel into an electrochemical cell absent additional electrolyte material.

12. The process of claim 1 wherein said first electrolyte material and said second electrolyte material comprise the same electrolyte material.
